(19) United States
(12) Patent Application Publication
(10) Pub. No.: US 2005/0120212 A1
(43) Pub. Date: Jun. 2, 2005

(54) Systems and method for the transparent management of document rights

(76) Inventors: Rajesh Kanungo, Sunnyvale, CA (US); Hemant Ambalal Thakkar, Cupertino, CA (US)

Correspondence Address: PERKINS COIE LLP, P.O. BOX 2168, MENLO PARK, CA, 94026, US

(21) Appl. No.: 10/389,488

(22) Filed: Mar. 14, 2003

Related U.S. Application Data
(60) Provisional application No. 60/364,982, filed on Mar. 14, 2002.
(60) Provisional application No. 60/397,597, filed on Jul. 23, 2002.
(60) Provisional application No. 60/420,313, filed on Oct. 23, 2002.
(60) Provisional application No. 60/432,866, filed on Dec. 11, 2002.

(51) Int. Cl. H04L 9/00

(52) U.S. Cl. 713/170

(57) ABSTRACT

Systems and methods are described for enabling documents to be controlled by a sender, in a manner which is transparent to any end recipients. The invention include mechanisms enabling a sender to control documents sent to recipient, in a manner that (1) encrypts the message to ensure its security, and (2) restricts operations the recipient may perform on the received message. The recipient and sender need not agree on a control protocol in advance of the communication. Wide distribution of a Digital Rights Management System may be facilitated by use of self-installing modules, which integrate with existing software used for document publishing and retrieval. The modules are forwarded to unregistered recipients upon authentication of the recipient, and install automatically on the recipient's computer. The modules authenticate instructions from a sender, and, per instructions from the sender, may pre-empt certain types of operations on the e-mail by the recipient

### CROSS-REFERENCE TO RELATED APPLICATIONS

This application claims priority to U.S. Provisional Patent Application No. 60/364,982, filed Mar. 14, 2002, U.S. Provisional Patent Application No. 60/397,597, filed Jul. 23, 2002, U.S. Provisional Patent Application No. 60/420,313, filed Oct. 23, 2002, and U.S. Provisional Patent Application No. 60/432,866, filed Dec. 11, 2002, all of which are hereby incorporated by reference in their entirety.

### FIELD OF THE INVENTION

The invention relates to the field of software, and more particularly to rights management for digital documents.

### DESCRIPTION OF RELATED ART

The field of Document Rights Management (DRM) has long been hampered by the complications of configuring cumbersome DRM software, and by the constraints imposed by existing DRM packages, which require senders and recipients to agree on DRM protocols and software in advance of any controlled communication. In standard DRM systems, a sender utilizing the DRM system may only control documents sent to a recipient if the recipient has, in advance of the document transfer, installed a reader for the particular DRM system. This limitation of existing DRM systems precludes a sender from controlling a document forwarded to an arbitrary recipient. Indeed, to ensure that the document will be both controlled and secure, the current state of the art forces the sender to ensure through an independent channel that the recipient has installed the appropriate software for reading the document. Otherwise, any controlled document forwarded to an uninitiated recipient is merely noise.

The inadequacies of existing DRM systems, in which senders and recipients must agree on a particular DRM package prior to the initiation, is further exacerbated by the multiplicity of existing DRM systems. The current art lacks a standard protocol or software package for DRM; users with mismatched DRM systems are precluded from controlling messages transferred amongst themselves.

The inadequacies of the existing internet infrastructure with respect to Digital Rights Management is be illustrated by the limitations of existing e-mail systems. The e-mail protocols currently deployed on the Internet—such as Multi-Purpose Internet Mail Extensions (MIME), and Simple Mail Transport Protocol (SMTP), as well as server protocols deployed for e-mail communication, such as Internet Message Access Protocol (IMAP) or Post Office Protocol 3 (POP3)—do not include provisions for controlling e-mails forwarded between senders and recipients. Thus any document control between senders and recipients of e-mail can only be undertaken by use of higher level applications, which have been agreed to in advance by the sender and recipient. Thus, a sender who wishes to send an e-mail message, to an arbitrary recipient, in a manner which disables certain operations on the e-mail message, has no tools available to facilitate this type of exchange.

In view of the limitations of the current art, there is a need for transparency in Document Rights Management Systems, to alleviate the complexity in installation and configuration of current DRM technology. Such Document Rights Management tools should also utilize existing communications infrastructure.

Additionally, there is a need for tools which facilitate control over documents forwarded to arbitrary users.

These and other inadequacies in the prior art are addressed by the inventor described herein.

### SUMMARY OF THE INVENTION

The invention comprises systems and methods of Digital Rights Management, which allows documents to be controlled by a sender, in a manner which is transparent to any end recipients. Embodiments of the invention include mechanisms enabling a sender to control documents sent to a recipient, in a manner that (1) encrypts the message to ensure its security, and (2) restricts operations the recipient may perform on the received message; this mechanism is transparent, in that the recipient and sender need not agree on a control protocol in advance of the communication.

Embodiments of the invention also include techniques for facilitating wide distribution of a Digital Rights Management System, in a manner which does not compromise the security of the DRM system. This distribution may be facilitated by use of self-installing modules, which integrate with existing software used for document publishing and retrieval. These modules may be forwarded to unregistered recipients upon authentication of the recipient, and may, upon acceptance by the recipient, install automatically on the recipient's computer. Accordingly, these self-installing modules leverage pre-existing software and communications infrastructure to facilitate controlled, secure communications.

In embodiments of the invention, the controlled document may comprise an e-mail message; the invention allows a sender to forward a controlled message via e-mail to an arbitrary user, and ensure that the user may read the controlled message transparently. In some such embodiments, the control mechanism comprises a plug-in module to the sender's otherwise standard e-mail composer; in embodiments, this plug-in module may be self-installing.

In embodiments of the invention, upon creation of the controlled message by the sender, a lookup is performed for the recipient, to determine whether or not the recipient is a registered user of the transparent DRM system. If the recipient's e-mail address is not located in the registry, this is indicative that the recipient does not have software configured to decode the secure e-mail. In some embodiments, a certificate may be generated automatically for the recipient and forwarded to the sender's e-mail client; this message may be encrypted by reference to the recipient's new certificate.

In embodiments of the invention, if the recipient is not located in a registry of the DRM system, an invitation may be forwarded to the recipient to read the attached message; the message may include an invitation to download an add-in enabling him to read the controlled document. If the recipient elects to receive the message, the invention facilitates a download of add-in software to the recipient's e-mail reader. In embodiments of the invention, the add-in software is designed for self-installation and for integration with the recipient's original e-mail reader. Upon installation and integration of the add-in to the recipient's e-mail reader, the message is controlled per the instructions of the sender.

These and other embodiments are elaborated in greater detail infra.

### DETAILED DESCRIPTION

### Overview and Use Cases

The invention comprises systems and methods for enabling documents to be controlled by a sender, in a manner which is transparent to any end recipients.

Embodiments of the invention include mechanisms enabling a sender to control an e-mail message sent to an end recipient, in a manner that restricts operations the recipient may perform on the received message; this mechanism is transparent, in that the recipient and sender need not agree on a control protocol in advance.

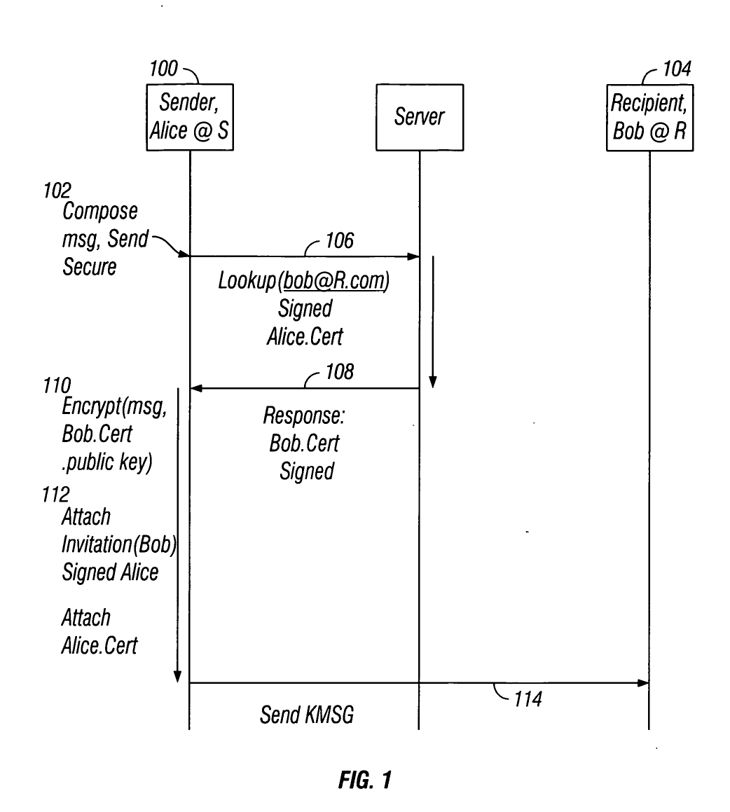

An illustrative example of the invention is depicted in the use case of FIG. 1. A sender, Alice (A) composes 102 a message intended for a recipient Bob (B) 104. Alice has access to an e-mail software configured to send e-mail securely. In some embodiments of the invention, Alice employs a standard e-mail client/composer, such as Microsoft Outlook™, which includes an add-in customized to provide document security and control.

Alice instructs the e-mail composer to send the message securely to Bob. In embodiments of the invention, this prompts the add-in component to perform lookup Bob's e-mail address (bob@R.com) 106; in embodiments of the invention, the request for the lookup by Alice is signed. If the corresponding e-mail address to Bob is not located on a registry, a response is sent back to Alice. In embodiments of the invention, a certificate for Bob may be generated and forwarded to Alice in the response. The message is encrypted by reference to Bob's new certificate. Subsequently, an invitation to Bob to read the message is attached, and the message and signed by Alice 112. The revised message is then forwarded directly to Bob 114. In embodiments of the invention, if it is determined that Bob does not have appropriate certifications or software to read the message, the message may include an invitation to download an add-in enabling him to read the encrypted software. In some nonlimiting embodiments, this invitation may be encoded in a markup language, such as, by way of non-limiting example, HTML.

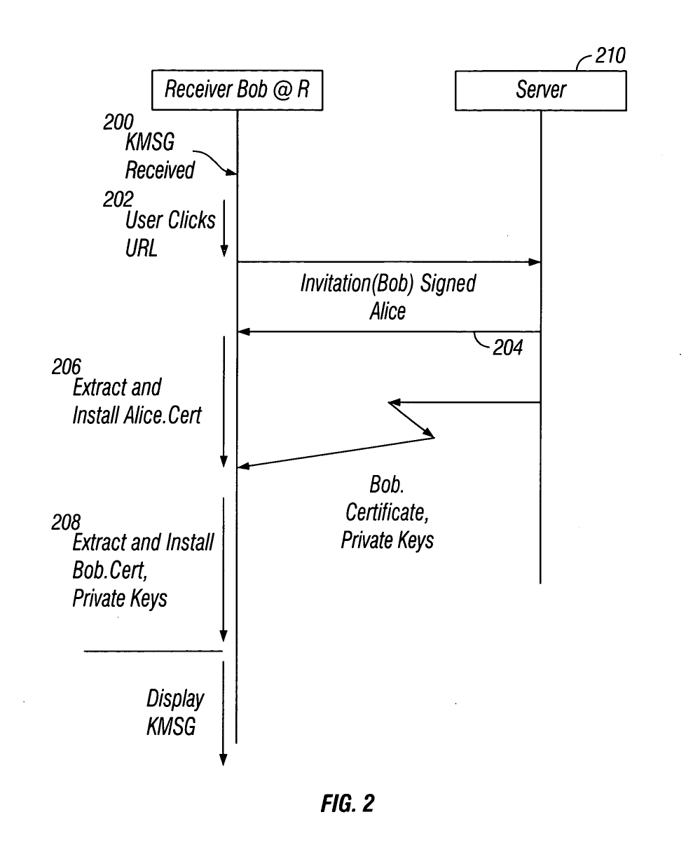

A corresponding use-case for Bob is illustrated in FIG. 2; note that in this case, Bob is using an e-mail reader which, at the outset, does not have any mechanisms that enable Alice to restrict Bob's use of the message. As an illustrative example, the e-mail reader may be Microsoft, Inc.'s Outlook™. In embodiments of the invention, the message as received by Bob includes an invitation to read the secure message. If Bob elects not to read the secure mail, he may deny the invitation; in embodiments of the invention, this prompts a response message to Alice, indicating that Bob is not interested in reading the secured mail. In some such embodiments, a message is also forwarded to a proprietary server indicating that any identity corresponding to Bob should be removed.

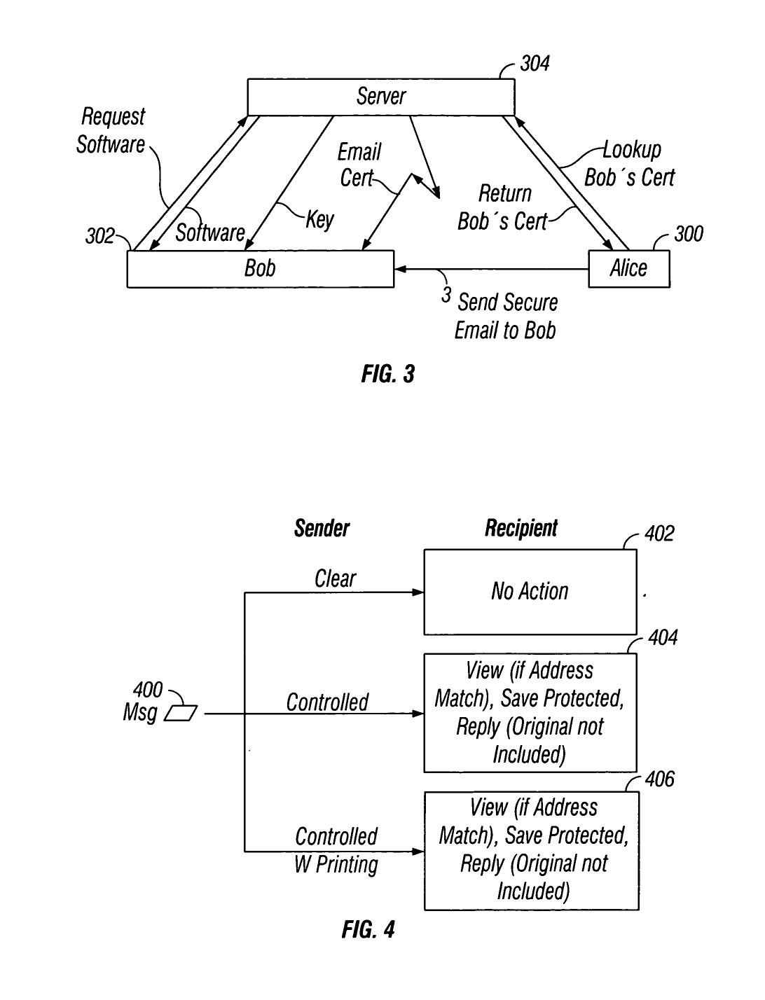

If Bob elects to receive the message 200, Bob may click on a URL embedded in the message 202. The URL links to a proprietary DRM server 210, which facilitates a download of the add in software to Bob's e-mail reader 204. The DRM add-in software is designed for self-installation and for integration with Bob's original e-mail reader. Alice's and Bob's certificates are extracted and installed, and the unencrypted message is displayed 208. FIG. 3 further illustrates relationships between the different entities in the DRM architecture, including the sender Alice 300, the recipient Bob 302, the DRM server 304, and the transactions between each of the entities.

### Features of the DRM System

The document control features available to an author of a message 400 are illustrated if FIG. 4. A message 400 may be sent in clear text, in which case no action is taken. Alternatively, the author may elect to control the message. In the non-limiting example illustrated in FIG. 4, the message 400 may be controlled to disable operations such as cut, copy, print, forward, save clear (i.e., save the message in decrypted clear text), save attachments; in this example 404, options such as Save in Protected Format and Reply Without Original Message may be included. As an alternative example 406, the message may be controlled to allow the message to be printed as a hardcopy.

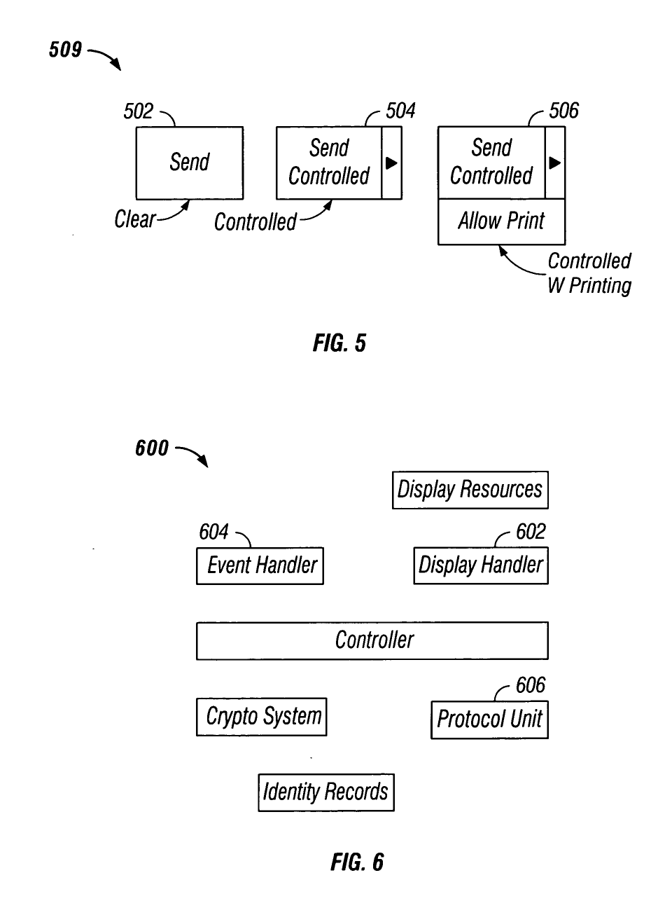

In embodiments of the invention, an add-in to the sender's e-mail composer may include a Graphical User Interface as illustrated in FIG. 5. By way of non-limiting example, a window for an e-mail message may include separate buttons for Send 502 and Send Controlled 504 options. The Send Controlled button 506 may, in turn, include multiple options, enabling/disabling other options, such as, by way of non-limiting example, a Print option 506.

The control options available to the author include:

Viewing the Message

The author has the alternative not to control the message, in which case the ordinary behavior of the e-mail reader is observed. If the message is controlled, the message can be opened and read if the local mail address matches one of the recipient addresses. In embodiments of the invention, this behavior obtains irrespective of the GUI representations of opening and viewing e-mails. These GUI representations may include by way of non-limiting examples, clicking on a message header to display a message in preview pane; double-clicking a message header to open a message window; and opening a saved e-mail document.

Cut or Copy

If the message is not controlled, the ordinary behavior of the e-mail client is observed. If the message is controlled, the message contents cannot be extracted by cut, copy, or drag and drop operations.

Print

If the message is not controlled, the ordinary behavior of the e-mail client is observed. If the message is controlled and print is enabled, the message can be printed. In embodiments of the invention, the printed message is watermarked with this recipient's e-mail address. If the message is controlled and print is disabled, the message cannot be printed.

Forward

If the message is not controlled, the ordinary behavior of the e-mail client is observed. However, if the message is controlled, the message cannot be forwarded by the recipient.

Save

If the message is not controlled, the ordinary behavior of the e-mail client is observed. In some embodiments, if the message is controlled, the message cannot be saved in clear text; in some embodiments, the message may be saved in encrypted format. In other embodiments, the save option in the e-mail reader and or operating system are disabled.

Save Attachments

If the message is not controlled, the normal behavior of the e-mail client is observed. If the message is controlled, attachments to the message cannot be saved.

Architecture of the Transparent Document Control Mechanism

In embodiments of the invention, the transparent control of e-mail messages is enabled by a software architecture comprised of components, which are responsible for concealing cryptographic, protocol, and control issues from application-specific issues such as display, event management, and the user experience. FIG. 6 illustrates a component architecture 600 used in embodiments of the invention, which includes Display Manager 602, Event Manager 604, a Protocol Unit 606.

In embodiments of the invention, the Event Manager 604 is responsible for trapping any events at the e-mail reader which could allow the replication of clear data. These events include application level operations such as cut, copy, paste, save, save-as, print, send, and forward; relevant events also include low-level events occurring in the operating system, such as mouse clicks, keystrokes, or other interrupts.

In embodiments of component architecture 600, The Display Manager 602 is responsible for several functions, including:
Installing and handling responses to buttons and menus inserted in the e-mail client by the add-in, as depicted in FIG. 5
Enabling/disabling the menu items and buttons
Displaying the arrival of secure message content
Displaying an invitation from the sender to the recipient to install the add-in and read a controlled message
Hiding encrypted messages from appearing in a preview plane; in some embodiments, an indicator is displayed for a secure message, as well as a pointer to a link for enabling the recipient to view the message in clear text

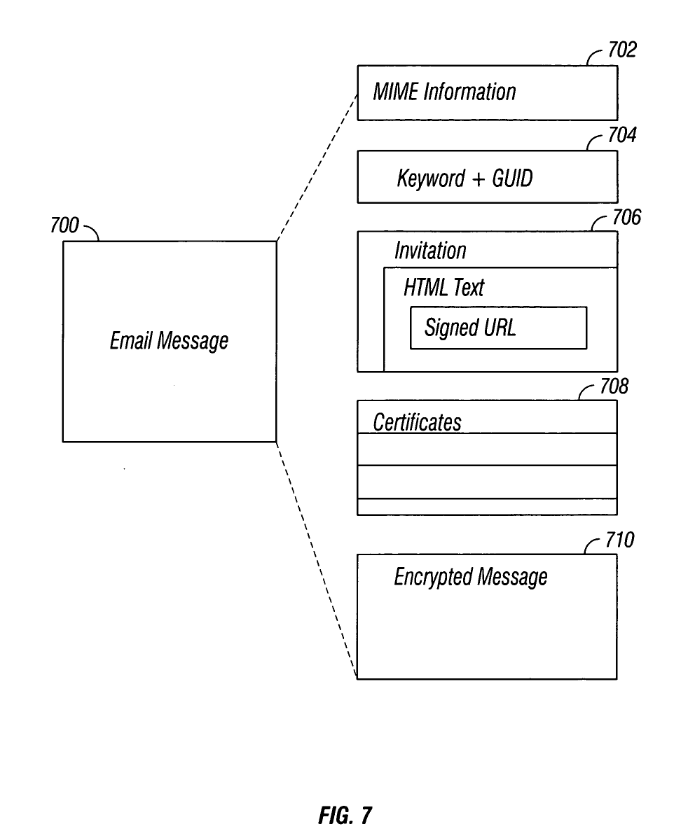

The Protocol Manager 606 handles the arrival of e-mail messages which may be controlled per the mechanism of the present invention. FIG. 7 illustrates an e-mail format which is interpreted, in embodiments of the invention, by the Protocol Manager 606. The message 700 includes the MIME header 702, further described in RFC 1521 and 1522, which are hereby incorporated by reference. The message further includes a keyword field 704, with a Global Indentifier.

In embodiments of the invention, the message format further includes text encoded in a markup language 706; non-limiting examples of such markup languages include Hyper Text Markup Language (HTML). By way of non-limiting example, the HTML text may comprise an invitation to download an add-in to the recipient's e-mail reader. In some such embodiments, the HTML text may include a signed URL which links to a site for download of the add-in. The message also includes one or more digital certificates, for authenticating the message. Finally, the message includes the original message in encrypted format 710, for decryption by the recipient.

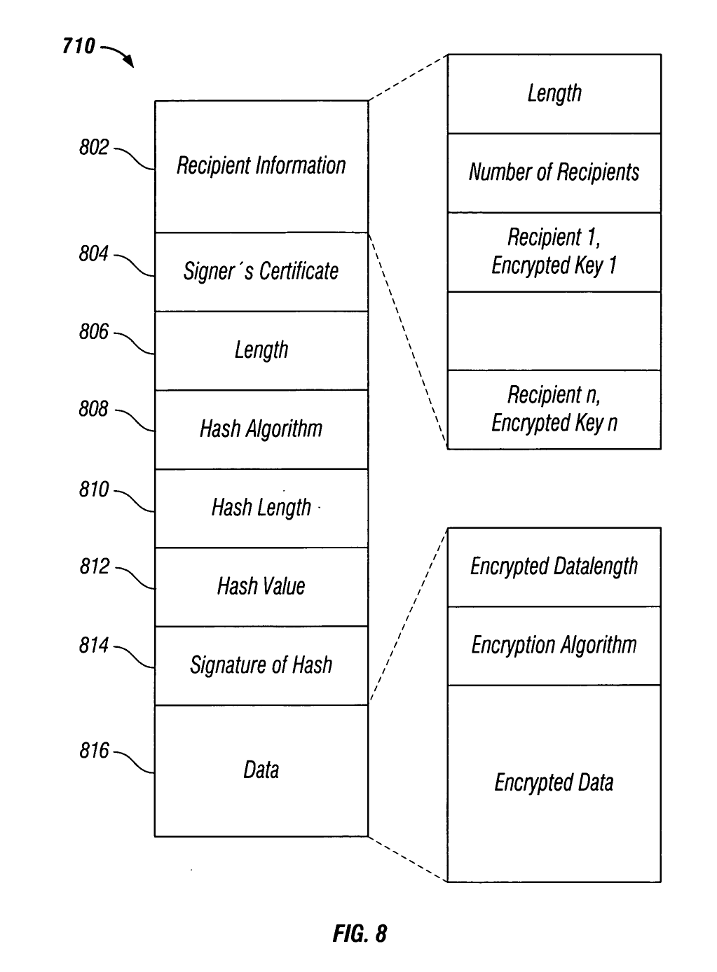

The encrypted message format 710 is elaborated upon in FIG. 8. In embodiments of the invention, the encrypted message includes a field for recipient information 802. The Recipient Information field may comprise any of the one or more following subfields:
A length field, indicating the length of the message
A subfield indicating the number of recipients of the message
One or more fields listing an encrypted key corresponding to each of the recipients.

The message may further include a signature from the sender 804, and a length key 806. In some embodiments of the invention, the message includes a field 808 indicating a hash that may be used; non-limiting examples of such hashes include the many instantiations of the Secured Hash Algorithm (SHA). In embodiments of the invention, the message may also include a length for the Hash 810, a value for the hash 812, and a signature for the hash 814. The message further includes a payload, or data field 816: the data field maybe further comprised by subfields including the length of the encrypted data, an identifier for an encryption algorithm used, and the encrypted data itself.

### Protocols for Transparent Document Control

Embodiments of the invention include numerous protocols for communication between senders and recipients of controlled messages. The protocols described herein are for illustrative purposes only; many equivalents and alternatives shall be apparent to those skilled in the art.

Sender-Side Protocols

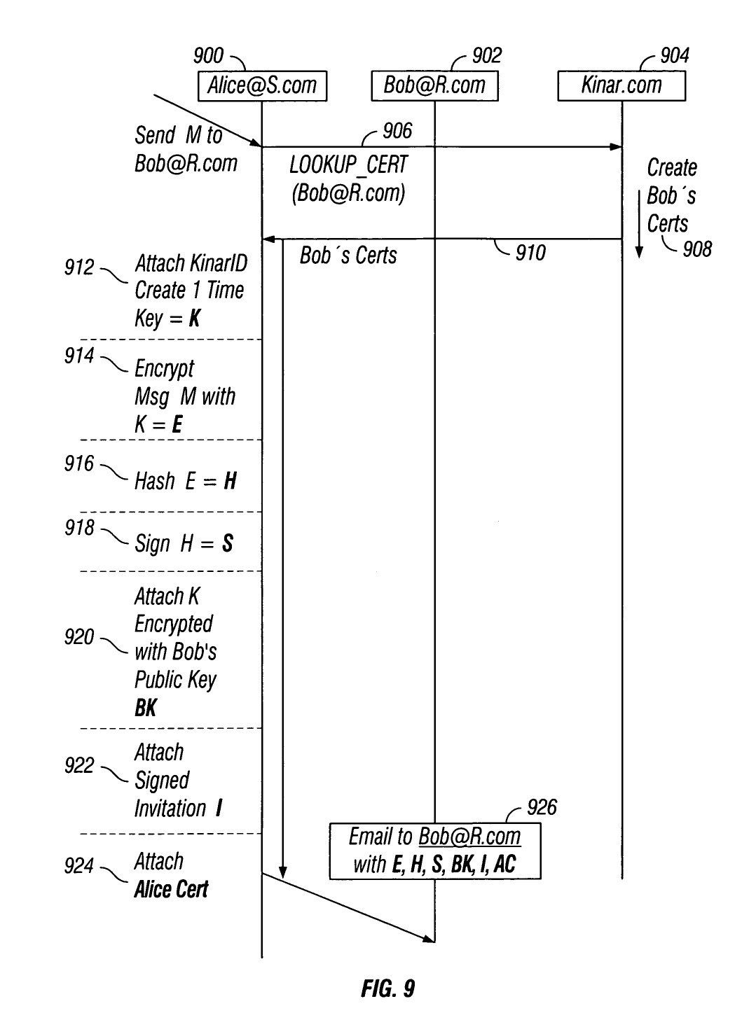

FIG. 9 illustrates in detail a use case for forwarding controlled e-mail according to embodiments of the invention. Three entities are depicted, the sender Alice (A) 900, the recipient Bob (B) 902, and a third party Security Server 904. Alice composes a message M for Bob, which triggers a lookup 906 for Bob's certificate. If no such certificate is available locally, one may be created 908 at the Security Server. A certificate for Bob is returned to Alice 910.

Upon receipt of Bob's certificate, a one time key K is created 912 for the message M. The message M is encrypted with K to generate an encrypted message E 914. The encrypted message E can be hashed to generate a hash H 916, and then signed by Alice to generate a signature S 918. The one-time key K can then be encrypted with Bob's public key to generate an encrypted vector BK 920, and a signed Invitation I can be generated for Bob to read the message 922. Alice's digital certificate AC may also be added to the message 924. At the end of the process, an e-mail is forwarded to Bob 926, containing the encrypted message E, the hashed encrypted message H, the signed hashed message S, the key K encrypted with Bob's public key BK, a signed invitation 1, and Alice's digital certificate AC.

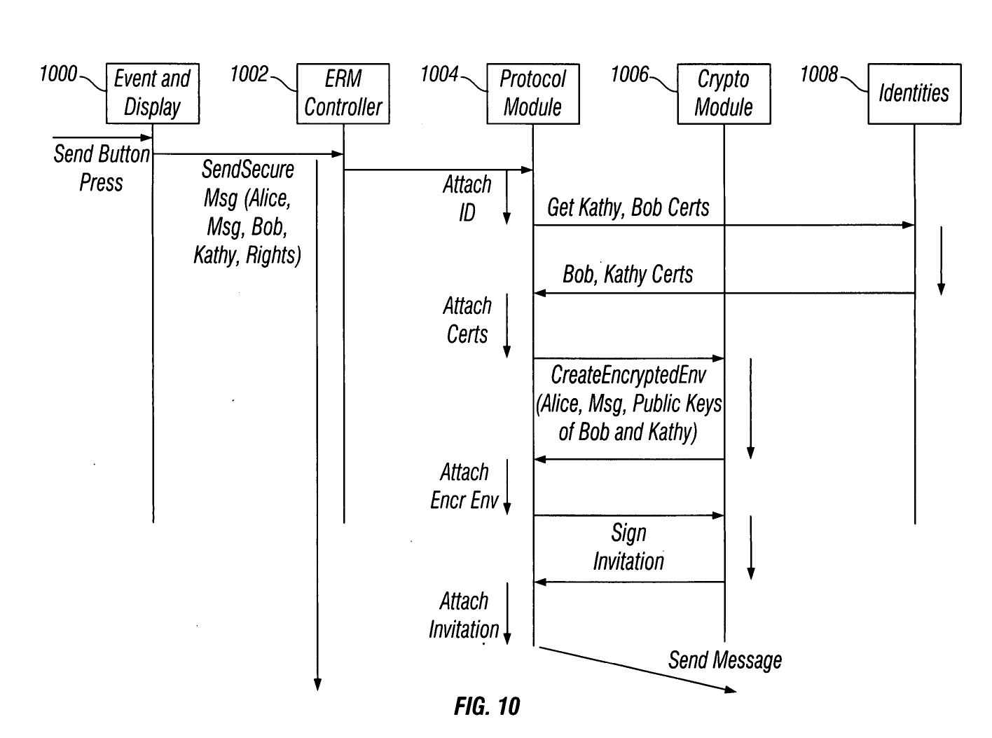

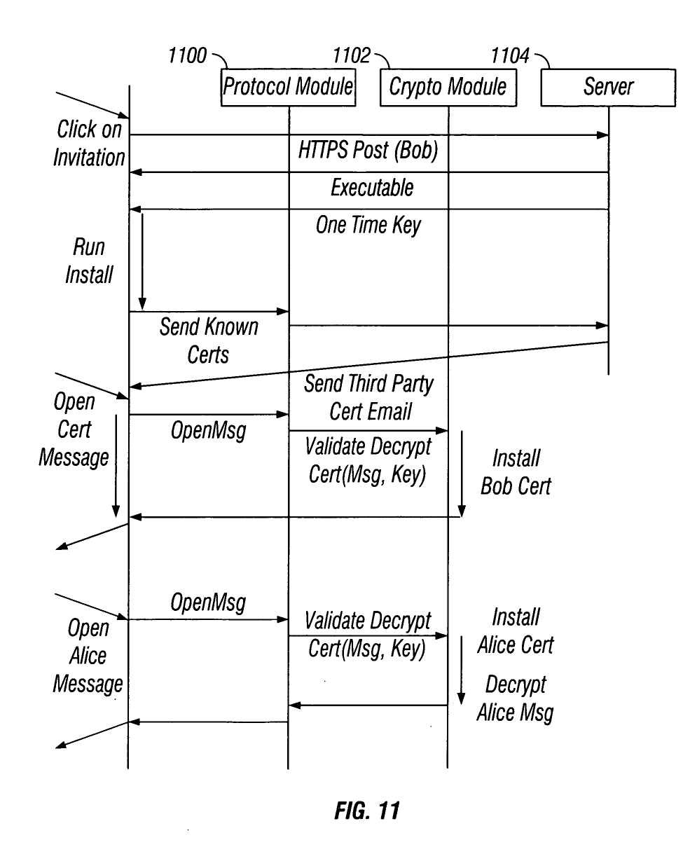

FIG. 10 illustrates an interaction between entities when Alice composes the message for sending to Bob, in accordance with the use case discussed with respect to FIG. 9. The entities depicted in FIG. 10 include one or more Event and Display modules 1000 on Alice's client program, an Enterprise Rights Management (ERM) controller 1002, a Protocol Module 1004, a Cryptographic module 1006, and an Identity Manager 1008. The Event Manager detects the engagement of the send button on Alice's client program. The protocol manager 1004 is responsible for attaching the ID, appropriate certificates, encryption environment, and invitation to the message. The Cryptographic module 1006 performs the appropriate cryptographic operations, such as signing the invitation, and the Identity Manager is responsible for obtaining the appropriate certificates.

Recipient-Side Protocols

Embodiments of the invention include protocols which enable controlled message to be received and read by new recipients transparently. FIG. 11 illustrates a process by which a recipient Bob can receive a first controlled message according to embodiments of the invention. The figure illustrates three entities, a Protocol Module 1100, and Cryptographic Module 1102, and a third party Security Server 1104.

The process commences when Bob clicks on the invitation I; in non-limiting embodiments of the invention, this invitation I embeds a URL. In some such embodiments, this causes Bob's e-mail client to post a message to the third party server. In non-limiting embodiments, this post may take place over a secure protocol, such as HTTPS. An executable for the add-in is downloaded from the third party server to Bob's client, along with a one-time key. The add-in self-installs on Bob's client.

Once the add-in has installed, known certificates are forwarded from the client to the Security Server. The secured e-mail generated by Alice 926 is then sent to Bob's client. In response, two actions are taken on the client side. First, a certificate message is opened on the client side. A command is sent to the Protocol Module to open the message, and a message is sent to the cryptographic module to validate the decryption. Once Bob's certificate is installed, Alice's message is opened. Again, a command is sent to the Protocol Module to open the message, and again, the decryption is validated by the Cryptographic module. Alice's certificate is installed, and the message from Alice is decrypted.

Once the add-in has been installed through the procedure above, Bob can read any subsequent messages transparently, simply by clicking on the message.

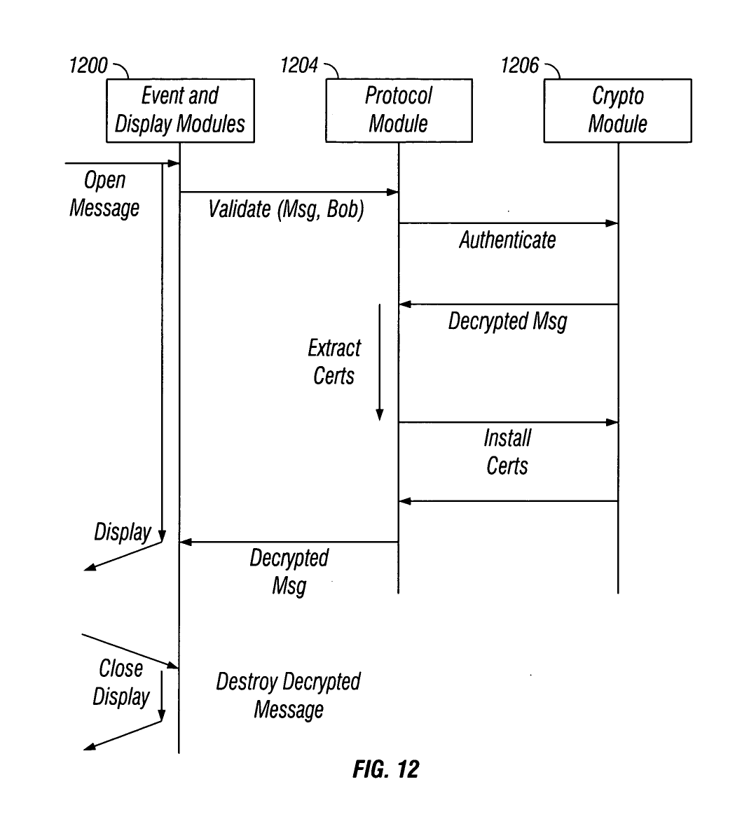

The underlying processes enabling the transparent receipt of messages is illustrated in FIG. 12. Event and Display modules 1200 are responsible for opening the message upon receipt. The Protocol Module 1204 validates the message, and the message is authenticated and decrypted by the cryptographic module 1206. The certificates are extracted by the protocol module 1204, and certificates are installed by the cryptographic module 1206. The decrypted message is ultimately displayed by the Event and Display Modules 1200, which are also responsible for closing the display and destroying the message.

### Conclusion

From the foregoing, it will be appreciated that specific embodiments of the invention have been described herein for purposes of illustration, but that various modifications may be made without deviating from the spirit and scope of the invention. Accordingly, the invention is not limited except as by the appended claims.

1. A method of transparently controlling an e-mail message, the method comprising:
composing an e-mail at an e-mail composer, composing the e-mail including inserting one or more control instructions in the e-mail;
forwarding the e-mail to a recipient, forwarding the e-mail message further including determining if an e-mail reader of the recipient has access to one or more control modules for decoding the one or more control instructions;
if the e-mail reader does not have the one or more control modules, downloading the control modules to the e-mail reader;
upon receipt of the e-mail message at the e-mail reader, executing the one or more control modules, executing the one or more control modules further including decoding the one or more control instructions.

2. The method of claim 1, wherein the one or more control instructions include an instruction to disable printing for the e-mail message.

3. The method of claim 1, wherein the one or more control instructions include an instruction to disable copying the e-mail message.

4. The method of claim 1, wherein the one or more control instructions include an instruction to disable replying to the e-mail message.

5. The method of claim 1, further comprising:
prior to forwarding the e-mail, encrypting the e-mail message.

6. The method of claim 5, wherein encrypting the e-mail further includes performing a Simple Hash Algorithm (SHA) on the e-mail.

7. The method of claim 5, wherein encrypting the e-mail further includes performing a Rivest-Shamir-Adleman (RSA) algorithm on the e-mail.

8. The method of claim 5, wherein encrypting the e-mail further includes performing a Pretty Good Privacy (PGP) algorithm on the e-mail.

9. The method of claim 1, wherein the e-mail message is in MIME format.

10. The method of claim 1, wherein the e-mail message is in SMTP format.

11. The method of claim 1, wherein the e-mail reader is in communication with an IMAP e-mail server.

12. The method of claim 1, wherein the e-mail reader is in communication with a POP e-mail server.

13. The method of claim 1, wherein the one or more control instructions include an instruction to disable saving of one or more attachments the e-mail message.

14. A secure e-mail format for an e-mail message, the secure e-mail format comprising:
a header in MIME format;
a recipient information field indicating an encrypted key for each of one or more recipients for the e-mail message;
a digital signature by a sender of the e-mail message;
a data field, the data field further comprising
a subfield indicating a length of encrypted data,
a subfield indicating an encryption algorithm used to encrypt the encrypted data, and
an encrypted payload field containing the encrypted data.

15. The secure e-mail format of claim 14, wherein the encryption algorithm is RSA.

16. The secure e-mail format of claim 14, wherein the encryption algorithm is PGP.

17. The secure e-mail format of claim 14, wherein the encryption algorithm is SHA.

18. A method of controlling access to an electronic document, comprising:
generating one or more flags for the electronic document, the one or more flags indicating access permissions for at least one recipient of the electronic document;
forwarding the electronic document to the at least one recipient in encrypted format, wherein forwarding the electronic document further includes forwarding the one or more flags with the electronic document, the one or more flags also in the encrypted format;
accessing the electronic document by the recipient via a client program;
receiving a command by the recipient at the client program for execution on the electronic document;
intercepting the command prior to execution;
comparing the one or more flags to the command;
in response to comparing the one or more flags to the command, permitting or denying execution of the command on the electronic document.

19. The method of claim 18, wherein the command is one of the group consisting of save, print, forward.

20. The method of claim 18, wherein the intercepting the command is performed by a plug-in module to the client program.

21. The method of claim 20, wherein the forwarding the electronic document includes forwarding the plug-in module to the recipient.

22. The method of claim 21, further comprising: prior to intercepting the command, installing the plug-in module to the client program.

23. The method of claim 18, wherein the encryption format includes a PKI encryption format.

24. The method of claim 18, wherein the encryption format includes a DES encryption format.

25. The method of claim 18, wherein the one or more flags are forwarded via a Simple Object Access Protocol.

26. The method of claim 18, wherein the encryption format includes a SHA encryption format.

27. The method of claim 18, wherein the encryption format includes an RSA encryption format.

28. The method of claim 18, wherein the encryption format includes a PGP encryption format.

29. A secure e-mail system comprising:
a client e-mail reader, the client e-mail reader executing on a first terminal in communication with an internetwork;
a source e-mail composer, the source e-mail composer executing on a second terminal in communication with the internetwork;
a self-installing add-in component for the client e-mail reader, wherein the add-in component is originally resident on a dedicated server accessible via the internetwork, such that the self-installing add-in component is operative to install itself on the first terminal upon downloading to the first terminal, and authenticate one or more instructions from the source e-mail composer, the one or more instructions intercepting and pre-empting commands from the client e-mail reader.

30. The secure e-mail system of claim 29, wherein the one or more instructions includes an instruction operative to pre-empt forwarding of e-mail messages.

31. The secure e-mail system of claim 29, wherein the one or more instructions includes an instruction operative to pre-empt copying of e-mail messages.

32. The secure e-mail system of claim 29, wherein the one or more instructions includes an instruction operative to pre-empt replying to e-mail messages.

33. The secure e-mail system of claim 29, wherein the one or more instructions includes an instruction operative to pre-empt saving of e-mail messages.

34. The secure e-mail system of claim 29, wherein the one or more instructions includes an instruction operative to pre-empt printing of e-mail messages.

35. An e-mail reader capable of reading MIME encoded messages, the e-mail reader comprising:
a first one or more software modules for validating sender certificates embedded in e-mail messages received by the e-mail reader;
a second one or more software modules for intercepting user commands, at the instruction of e-mail messages validated by the first one or more software modules.

36. The e-mail reader of claim 35, wherein the user commands include a forwarding instruction.

37. The e-mail reader of claim 35, wherein the user commands include a print instruction.

38. The e-mail reader of claim 35, wherein the user commands include a save instruction.

39. The e-mail reader of claim 35, wherein the user commands include a copy instruction.

40. A computer program product comprising:
a computer usable medium having computer readable program code means embodied therein for reading secure e-mail, the computer readable program code means in said computer program product comprising:
computer readable program code means for causing a computer to open an e-mail message;
computer readable program code means for causing the computer to authenticate a sender of the message; and
computer readable program code means for causing the computer to preempt one or more commands from a reader of the e-mail, wherein flags for preempting the one or more commands are embedded in the e-mail by the authenticated sender.

41. A program storage device readable by a machine, tangibly embodying a program of instructions executable by the machine to perform method steps for reading secure e-mail, the method steps comprising;
authenticating an encrypted e-mail;
reading one or more flags in the authenticated e-mail, the one or more flags identifying user commands to be pre-empted;
pre-empting one or more user commands indicated by the one or more flags.

42. The program storage device of claim 41, wherein the one or more user commands includes a forward command.

43. The program storage device of claim 41, wherein the one or more user commands includes a print command.

44. The program storage device of claim 41, wherein the one or more user commands includes a save command.

45. The program storage device of claim 41, wherein the one or more user commands includes a copy command.
